(19) United States
(12) Patent Application Publication
(10) Pub. No.: US 2013/0014140 A1
(43) Pub. Date: Jan. 10, 2013

(54) PLAYING DEVICE AND PLAYING METHOD

(75) Inventors: Changchun Ye, Beijing (CN); Xianfeng Wang, Beijing (CN)

(73) Assignees: BEIJING LENOVO SOFTWARE LTD., Beijing (CN); LENOVO (BEIJING) LIMITED, Beijing (CN)

(21) Appl. No.: 13/634,825

(22) PCT Filed: Feb. 23, 2011
(86) PCT No.: PCT/CN2011/000283

§ 371 Date: Sep. 13, 2012

(30) Foreign Application Priority Data
Mar. 29, 2010 (CN) 201010136600.2

(51) Int. Cl. H04N 7/00

(52) U.S. Cl. 725/9

(57) ABSTRACT

A playing device and a play method are provided. The playing device includes a playing module configured to play a first media stream currently being received; a first monitoring module configured to monitor whether the first media stream contains a content a user does not want to watch and generate a monitor result; and a first controlling module configured to control the playing module to play a second media stream in response to the monitor result indicating that the first media stream contains the content the user does not want to watch, the second media stream being different from the first media stream and containing a content the user wants to watch.

### TECHNICAL FIELD

The present invention relates to television (TV) technology, and more particularly, to a playing device and a playing method.

### BACKGROUND

Inserting advertisements in TV programs has become predominant for TV stations to increase their revenues. However, TV users are running out of patience with the advertisements inserted in TV programs. Unfortunately, TV stations have always monopolized broadcasting technology for TV programs. TV users have to passively accept, but cannot effectively block, the inserted advertisements.

Conventionally, when an advertisement is inserted and broadcasted in a TV program, a TV user may manually switch TV channels to search his or her favorite TV program. However, the user can only switch between these TV channels purposelessly, and thus it is impossible for the user to find his or her favorite TV program in a convenient and rapid manner.

### SUMMARY

In view of the above, a playing device and a playing method are provided capable of effectively blocking a content a user does not want to watch.

In order to solve at least the above problems, in an embodiment of the present invention, a playing device is provided, which includes: a playing module configured to play a first media stream currently being received; a first monitoring module configured to monitor whether the first media stream contains a content a user does not want to watch and to generate a monitor result; and a first controlling module configured to control the playing module to play a second media stream in response to the monitor result indicating that the first media stream contains the content the user does not want to watch, the second media stream being different from the first media stream and containing a content the user wants to watch.

In another embodiment of the present invention, a playing method is provided,

which includes: playing a first media stream currently being received; monitoring whether the first media stream contains a content a user does not want to watch, and generating a monitor result; and playing a second media stream in response to the monitor result indicating that the first media stream contains the content the user does not want to watch, the second media stream being different from the first media stream and containing a content the user wants to watch.

According to embodiments of the present invention, when a first media stream currently being received contains the content the user does not want to watch, the content the user does not want to watch can be automatically blocked from being played, and instead, a second media stream containing the content the user wants to watch can be played. In this way, a user can be exempted from being disturbed by the content he or she does not want to watch. In addition, it is possible to switch back to the previously watched first media stream after the play time for the content the user does not want to watch has ended, thereby improving user experience.

### BRIEF DESCRIPTION OF THE DRAWINGS

FIG. 1 is a schematic diagram showing a structure of a playing device according to an embodiment of the present invention;

FIG. 2 is a schematic diagram showing another structure of a playing device according to an embodiment of the present invention;

FIG. 3 is a flowchart illustrating a playing method according to an embodiment of the present invention;

FIG. 4 is a flowchart illustrating another playing method according to an embodiment of the present invention;

FIG. 5 is a flowchart illustrating yet another playing method according to an embodiment of the present invention;

FIG. 6 is a flowchart illustrating still yet another playing method according to an embodiment of the present invention; and

FIG. 7 is a schematic diagram showing yet another structure of a playing device according to an embodiment of the present invention.

### DETAILED DESCRIPTION OF THE PREFERRED EMBODIMENTS

The particular embodiments will be further detailed in the following with reference to the figures.

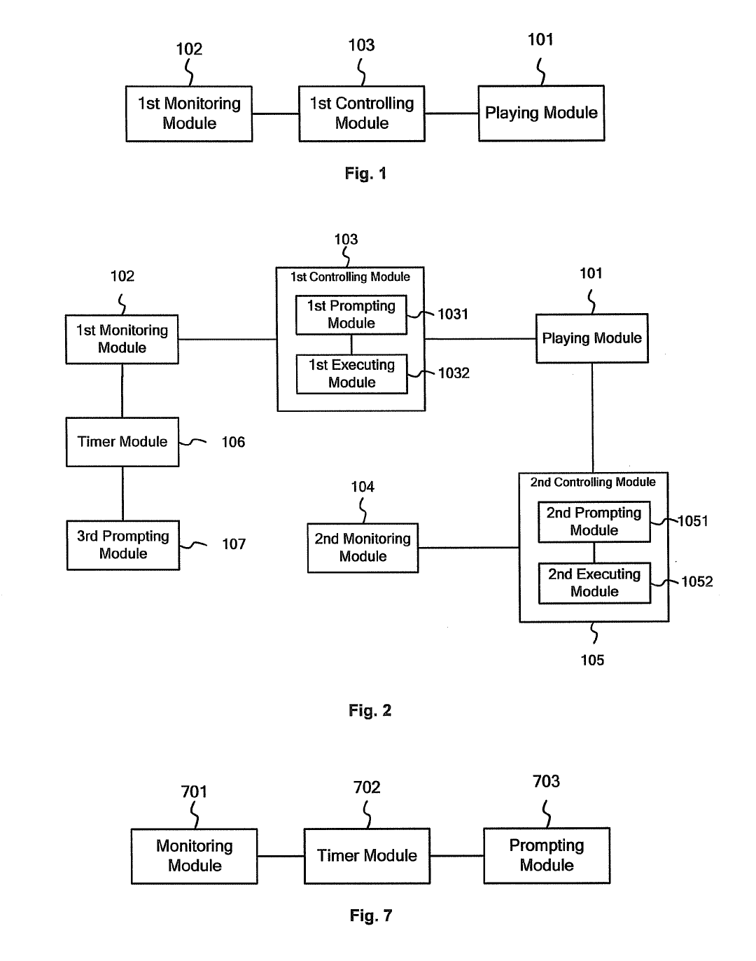

FIG. 1 is a schematic diagram showing a structure of a playing device according to an embodiment of the present invention. The playing device may be a TV, a Set Top Box (STB) connected to a TV display screen, a computer, a handset or the like. The playing device may include a playing module 101 which can be used to play various media streams such as video, music, picture and webpage.

Suppose that the media source currently being played by the playing module 101 is a first media stream which may contain two types of contents, a content the user wants to watch and a content the user does not want to watch. Which types of contents the user does or does not want to watch may be set by the user in advance and stored in the playing device. For example, the content the user wants to watch may be TV series and movies, while the content the user does not want to watch may be advertisements and news.

Conventionally, when the first media stream currently being played contains content the user does not want to watch, the user needs to search for another media stream for playing by manually switching between the channels. In this way, it is not convenient for the user to find a desired media stream.

In order to automatically block the content the user does not want to watch, the playing device according to an embodiment of the present invention further includes:

a first monitoring module 102 configured to monitor whether the first media stream currently being received contains the content the user does not want to watch and generate a monitor result; and

a first controlling module 103 configured to control the playing module 101 to play a second media stream when the monitor result indicates that the first media stream contains the content the user does not want to watch, the second media stream being different from the first media stream and containing the content the user wants to watch.

Here, the second media stream may be a local media stream stored in advance in the playing device, e.g., a locally stored video file (e.g., a movie file), a music file (e.g., an mp3 file), a picture or a webpage. The playing device may acquire a storage path of the local media stream, and play the local media stream based on the storage path.

Alternatively, the second media stream may be a network media stream on the Internet. The playing device may acquire the network address of the network media stream, and play the network media stream based on the network address.

As another alternative, the second media stream may be a media stream on a is preset TV channel. The playing device may acquire the channel information of the preset TV channel, and play the media stream on the preset TV channel based on the channel information.

It is to be noted that, after switching to the preset TV channel, it is possible to continue monitoring the media stream on the preset TV channel as currently received. If it is detected that the media stream on the preset TV channel as currently received contains a content the user does not want to watch, it is possible to switch to another preset TV channel or a local media stream or a network media stream, until a second media stream whose current content is the content the user wants to watch is found.

The storage path of the local media stream, the network address of the network media stream and the channel information of the preset TV channel, as described above, may be set by the user in advance and stored in a built-in memory in the playing device or an external memory connected to the playing device (e.g., a USB disk or a removable hard disk).

When it is monitored that the first media stream currently being received contains the content the user does not want to watch, the playing device may immediately stop receiving the first media stream. Alternatively, the playing device may continue receiving the first media stream without playing it. As another alternative, the first and the second media streams may be played in a dual-window mode. That is, two play windows can be displayed on the display screen for playing the first and the second media streams, respectively. For example, the second media stream may be played in a larger play window to be watched by the user, while the first media stream may be played in a smaller play window which is displayed at the upper left corner of the display screen, for example.

With the playing device according to the above embodiment, when the first media stream currently being received contains the content the user does not want to watch, the content the user does not want to watch may not be played, and the second media stream containing the content the user wants to watch may be played instead, such that the user will not be disturbed by the content he or she does not want to watch.

In the above embodiment, there may be a number of approaches to determine whether the first media stream currently being received contains the content the user does not want to watch, which will be detailed in the following.

The first monitoring approach is as follows.

It is assumed that, in a media stream, different media contents may be distinguished by different labels. For example, a label “1” may be added to the first byte of a media stream to indicate that the media stream relates to a movie, while a label “0” may be added to the first byte of the media stream to indicate that the media stream relates to an advertisement.

A label for the content the user does not want to watch may be stored in advance in the playing device. A label monitoring program may be installed in the playing device to detect the label for the media content currently received, so as to determine whether the received content is the content the user does not want to watch.

The first monitoring module 102 may include the following components for implementing the above label monitoring function:

a label detecting module configured to detect a label for media content contained in the first media stream currently being received and to generate a detection result; and

a first determining module configured to determine that the first media stream currently being received contains the content the user does not want to watch when the detection result indicates that the label for media content contained in the first media stream currently being received is a label for a content the user does not want to watch.

The second monitoring approach is as follows.

It is assumed that the TV programs to be played in a particular day on a TV channel, and the play time thereof are preset. For example, a TV channel, CCTV1, will play “News Broadcast” at 19:00 and “Weather Forecast” at 19:40, with advertisements inserted between the “News Broadcast” and “Weather Forecast”. These TV programs and their play time may be stored in advance in a play time table. When a user watches the TV channel CCTV1 on the playing device, the playing device may download the play time table from a may server (in some cases the TV channel may automatically transmit the play time table to the playing device), and obtain the play time for the content the user does not want to watch from the play time table. Meanwhile, a play time monitoring program may be provided to monitor whether the play time for the content the user does not want to watch has started. When it is monitored that the play time for the content the user does not want to watch has started, it may be determined that the first media stream currently being received contains the content the user does not want to watch.

The first monitoring module 102 may include the following components for implementing the above label monitoring function:

an acquiring module configured to acquire play time for the content the user does not want to watch as contained in the first media stream;

a play time monitoring module configured to set a timer for the play time, monitor whether the play time for the content the user does not want to watch has started, and generate a monitor result; and

a second determining module configured to determine that the first media stream contains the content the user does not want to watch when the monitor result indicates that the play time for the content the user does not want to watch has started.

The third monitoring approach is as follows.

The playing device may compare the currently received video frame with one or more previously received video frames, and calculate the correlation between them to determine whether the currently received video frame is a video frame for the content the user does not want to watch. In this way, it is possible to determine whether the first media stream currently being received contains the content the user does not want to watch.

The first monitoring module 102 can include the following components for implementing the above label monitoring function:

a video frame acquiring module configured to acquire a currently received video frame;

a correlation calculating module configured to compare the currently received video frame with one or more previously received video frames and calculate a correlation between the currently received video frame and the one or more previously received video frames; and

a third determining module configured to determine that the first media stream contains the content the user does not want to watch when the correlation is smaller than a preset threshold.

The fourth monitoring approach is as follows.

The playing device may be provided in advance with a video frame database in which a first video frame for the content the user does not want to watch is stored. A video frame matching program can also be provided to match the currently received video frame with the first video frame. When the currently received video frame matches the first video frame, it is determined that the first media stream currently being received contains the content the user does not want to watch.

The first monitoring module 102 may include the following components for implementing the above label monitoring function:

a storing module configured to store a first video frame for a content the user does not want to watch;

a video frame matching module configured to match a currently received video frame with the first video frame and generate a match result; and

a fourth determining module configured to determine that the first media stream contains the content the user does not want to watch when the match result indicates that the currently received video frame matches the first video frame.

In addition to the above monitoring approaches, the playing device may use other approaches to monitor whether the first media stream currently being received contains the content the user does not want to watch. The present invention is not limited to the above approaches.

As described in connection with the above embodiments, when the first media stream currently being received contains the content the user does not want to watch, playing of the content the user does not want to watch may be automatically stopped, and the second media stream may be played instead. In this way, the content the user does not want to watch can be effectively blocked. However, in some cases, even if the first media stream currently being received contains the content the user does not want to watch, the user may wish that the first media stream may continue to be played. In such cases, automatic switching to the second media stream disobeys the user's intention. Thus, in a preferred embodiment, upon detecting that the first media stream currently being received contains the content the user does not want to watch, the playing device may first prompt the user as to whether to switch to the second media stream or not, for example, by displaying switching prompt information on the display screen. The switch operation may be performed if the user instructs to switch to the second media stream. Otherwise, the first media stream may continue to be played.

As shown in FIG. 2, the first controlling module 103 in the playing device may further include:

a first prompting module 1031 configured to prompt the user as to whether to play the second media stream (e.g., by displaying switching prompt information at the lower right corner of the TV display screen) when the monitor result indicates that the first media stream contains the content the user does not want to watch; and

a first executing module 1032 configured to control the playing module 101 to play the second media stream upon receiving a confirmation instruction that the user wants to play the second media stream.

The user may select whether to switch to the second media stream by using a TV remoter, a mouse or a keyboard. If the user selects to switch to the second media stream, the playing device acquires and plays the second media stream. If the user selects not to switch to the second media stream, the playing device continues playing the first media stream. If the user does not make any selection, the playing device may operate according to predetermined settings. For example, the user may autonomously set that making no selection means switching or not switching.

Typically, the user may wish to switch back to the first video stream he or she previously watched, after the content the user does not want to watch has finished. According to an embodiment of the present invention, the playing device may monitor whether the content the user does not want to watch contained in the first media stream has finished, while playing the second media stream. Upon monitoring that the content the user does not want to watch has finished, the playing device may resume playing of the first media stream.

As shown in FIG. 2, the playing device further includes:

a second monitoring module 104 configured to monitor whether play time for the content the user does not want to watch has ended and to generate a monitor result;

a second controlling module 105 configured to control the playing module 101 to play the first media stream when the monitor result indicates that the play time for the content the user does not want to watch has ended.

There may be a number of approaches for the second monitoring module 104 to determine whether the play time for the content the user does not want to watch has ended, which will be detailed in the following.

The first monitoring approach is as follows.

If the playing device continues receiving the first media stream after switching to the second media stream, then the second monitoring module 104 may monitor whether the reception of the content the user does not want to watch as contained in the first media stream has finished (or whether the content the user wants to watch is currently being received) based on the received label for the media content in the first media stream. If it is monitored that the reception of the content the user does not want to watch has finished, it is determined that the play time for the content the user does not want to watch has ended.

The second monitoring approach is as follows.

Prior to switching to the second media stream, the playing device can acquire the play time for the content the user does not want to watch (e.g. by downloading a program play time table from a server) and start a timer for the play time for the content the user does not want to watch. After the timer has expired, it is determined that the play time for the content the user does not want to watch has ended.

The third monitoring approach is as follows.

Upon monitoring that the first media stream contains the content the user does not want to watch, the playing device may acquire the play time for the content the user does not want to watch and set a timer for the play time.

Regardless of whether the user decides to switch to the second media stream or not, the timer information may be displayed on the display screen of the playing device. In particular, the play time for the content the user does not want to watch may be displayed in a countdown or a time bar form, such that the user may determine whether the play time for the content the user does not want to watch has ended based on the timer information. Further, in the case where the user has decided to switch to the second media stream, and the timer information indicates that the play time for the content the user does not want to watch has ended, the user may switch back to the first media stream by using a TV remoter, a mouse or a keyboard.

The playing device further includes:

a timer module 106 configured to set a timer for the play time for the content the user does not want to watch when the monitor result indicates that the first media stream contains the content the user does not want to watch and generate timer information; and

a third prompting module 107 configured to prompt the timer information to the user such that the user may determine whether the play time for the content the user does not want to watch has ended based on the timer information.

The fourth monitoring approach is as follows.

If the playing device plays the first and the second media streams simultaneously in a dual-window mode, the user may watch the playing window corresponding to the first media stream by himself or herself to see whether the content the user does not want to watch has finished. Upon seeing that the content the user does not want to watch has finished, the user may change the playing window for the first media stream into a full-screen mode and close the playing window for the second media stream by using a TV remoter, a mouse or a keyboard.

It is to be understood that the playing device may maintain information on the first media stream (e.g., channel information, network address information, etc.) while switching to the second media stream. When the play time for the content the user does not want to watch as contained in the first media stream has ended, the playing device may switch back to the first media stream based on the maintained information on the first media stream.

However, in some cases, after switching to the second media stream, the user may not wish to switch back to the first media stream. Thus, in a preferred embodiment, upon determining that the play time for the content the user does not to want to watch as contained in the first media stream has ended, the playing device may prompt the user as to whether to switch back to the first media stream. For example, switching prompt information may be displayed on the display screen for prompting the user as to whether to switch or not. If the user instructs to switch back to the first media stream, the playing device performs the switching operation; otherwise, it continues playing the second media stream.

As shown in FIG. 2, the second controlling module 105 may further include:

a second prompting module 1051 configured to prompt the user as to whether to play the first media stream when the monitor result indicates that the play time for the content the user does not want to watch has ended; and

a second executing module 1052 configured to control the playing module 101 to play the first media stream upon receiving a conformation instruction that the user wants to play the first media stream.

Again, for different playing devices, the user may select whether to switch back to the first media stream or not by using a TV remoter, a mouse or a keyboard. If the user selects to switch back to the first media stream, the playing device performs the switching operation. If the user selects not to switch back to the first media stream, the playing device continues playing the second media stream. If the user does not make any selection, the playing device may operate according to predetermined settings, for example, the user may autonomously set that making no selection means switching back or not switching back.

In the following embodiments, the playing device according to the present invention will be explained with advertisements being the content the user does not want to watch.

In order to automatically block advertisements, the playing device according to an embodiment of the present invention includes:

a playing module configured to play various media streams, such as video, music, picture and webpage;

a first monitoring module configured to monitor whether the first media stream currently being received contains an advertisement and generate a monitor result; and

a first controlling module configured to control the playing module to play a second media stream when the monitor result indicates that the first media stream contains the advertisement, the second media stream being different from the first media stream.

Here, the second media stream may be a local media stream stored in advance in the playing device, e.g., a locally stored video file, a music file, a picture or a webpage. The playing device may acquire the storage path of the local media stream and play the local media stream based on the storage path.

Alternatively, the second media stream may be a network media stream on the Internet. The playing device may acquire the network address of the network media stream and play the network media stream based on the network address.

As another alternative, the second media stream may be a media stream on a preset TV channel. The playing device may acquire the channel information of the preset TV channel and play the media stream on the preset TV channel based on the channel information.

It is to be noted that, after switching to the preset TV channel, it is possible to continue monitoring the media stream on the preset TV channel as currently received. If it is detected that the media stream on the preset TV channel as currently received contains an advertisement, it is possible to continue switching to another preset TV channel or a local media stream or a network media stream, and so on, until a TV channel containing no advertisement is found.

The storage path of the local media stream, the network address of the network media stream and the channel information of the preset TV channel, as described above, may be configured by the user in advance and stored in a built-in memory in the playing device or an external memory connected to the playing device.

When it is monitored that the first media stream currently being received contains an advertisement, the playing device may immediately stop receiving the first media stream. Alternatively, the playing device may continue receiving the first media stream without playing it. As another alternative, the first and the second media streams may be played in a dual-window mode. That is, two play windows may be displayed on the current display screen for playing the first and the second media streams, respectively. For example, the second media stream may be played in a larger play window to be watched by the user, while the first media stream can be played in a smaller play window.

With the playing device according to the above embodiment, when the first media stream currently being received contains an advertisement, the advertisement may not be played and the second media stream may be played instead, such that the user will not be disturbed by the advertisement.

In the above embodiment, there may be a number of approaches to determine whether the first media stream currently being received contains an advertisement, which will be detailed in the following.

The first monitoring approach is as follows.

It is assumed that, in a media stream, different media contents can be distinguished by different labels. For example, a label “1” may be added to the first byte of the media stream to indicate that the media stream relates to a movie, while a label “0” may be added to the first byte of the media stream to indicate that the media stream relates to an advertisement.

A label for an advertisement may be stored in advance in the playing device. A label monitoring program may be installed in the playing device to detect the label for the media content currently received, so as to determine whether the received content is an advertisement.

The first monitoring module may include the following components for implementing the above label monitoring function:

a label detecting module configured to detect a label for media content contained in the first media stream currently being received and generate a detection result; and

a first determining module configured to determine that the first media stream currently being received contains an advertisement when the detection result indicates that the label for media content contained in the first media stream currently being received is a label for an advertisement.

The second monitoring approach is as follows.

Suppose that the TV programs to be played in a particular day on a TV channel and the play time thereof are preset. For example, a TV channel, CCTV1, will play “News Broadcast” at 19:00 and “Weather Forecast” at 19:40, with advertisements inserted between the “News Broadcast” and “Weather Forecast”. These TV programs and their play time may be stored in advance in a play time table. When a user watches the TV channel CCTV1 through the playing device, the playing device may download the play time table from a server (in some cases the TV channel may automatically transmit the play time table to the playing device) and obtain the play time for the advertisements from the play time table. Meanwhile, a play time monitoring program may be provided to monitor whether the play time for the advertisements has started. When it is monitored that the play time for the advertisements has started, it may be determined that the first media stream currently being received contains the advertisements.

The first monitoring module may include the following components for implementing the above label monitoring function:

an acquiring module configured to acquire play time for an advertisement as contained in the first media stream;

a play time monitoring module configured to set a timer for the play time, monitor whether the play time for the advertisement has started and generate a monitor result; and

a second determining module configured to determine that the first media stream contains the advertisement when the monitor result indicates that the play time for the advertisement has started.

The third monitoring approach is as follows.

The playing device may compare the currently received video frame with one or more previously received video frames and calculate the correlation between them to determine whether the currently received video frame is a video frame for an advertisement. In this way, it is possible to determine whether the first media stream currently being received contains an advertisement.

From the above, the first monitoring module can include the following components for implementing the above label monitoring function:

a video frame acquiring module configured to acquire a currently received video frame;

a correlation calculating module configured to compare the currently received video frame with one or more previously received video frames and calculate a correlation between the currently received video frame and the one or more previously received video frames; and

a third determining module configured to determine that the first media stream contains an advertisement when the correlation is smaller than a preset threshold.

The fourth monitoring approach is as follows.

The playing device may be provided with a video frame database in advance to store a first video frame for an advertisement. A video frame matching program may also be provided to match the currently received video frame with the first video frame. When the currently received video frame matches the first video frame, it is determined that the first media stream currently being received contains the advertisement.

The first monitoring module may include the following components for implementing the above label monitoring function:

a storing module configured to store a first video frame for an advertisement;

a video frame matching module configured to match a currently received video frame with the first video frame and generate a match result; and

a fourth determining module configured to determine that the first media stream contains the advertisement when the match result indicates that the currently received video frame matches the first video frame.

In addition to the above monitoring approaches, the playing device may use other approaches to monitor whether the first media stream currently being received contains an advertisement. The present invention is not limited to the above approaches.

As described in connection with the above embodiments, when the first media stream currently being received contains an advertisement, the advertisement may not be played and the second media stream may be played instead. In this case, the advertisement can be effectively blocked. However, in some cases, even if the first media stream currently being received contains an advertisement, the user may wish that the first media stream can continue to be played. In such cases, automatic switching to the second media stream disobeys the user's intention. Thus, in a preferred embodiment, upon detecting that the first media stream currently being received contains an advertisement, the playing device may first prompt the user as to whether to switch to the second media stream or not, for example, by displaying switching prompt information on the display screen. The switching operation may be performed if the user instructs to switch to the second media stream. Otherwise the first media stream may continue to be played.

The first controlling module in the playing device may further include:

a first prompting module configured to prompt the user as to whether to play the second media stream (e.g., by displaying switching prompt information at the lower right corner of the TV display screen) when the monitor result indicates that the first media stream contains an advertisement; and

a first executing module configured to control the playing module to play the second media stream upon receiving a confirmation instruction that the user wants to play the second media stream.

For different playing devices, the user may select whether to switch to the second media stream or not by using a TV remoter, a mouse or a keyboard. If the user selects to switch to the second media stream, the playing device acquires and plays the second media stream. If the user selects not to switch to the second media stream, the playing device continues playing the first media stream. If the user does not make any selection, the playing device may operate according to predetermined settings, for example, the user may autonomously set that making no selection means switching back or not switching back.

Typically, after the advertisement has finished, the user may wish to switch back to the first video stream he or she previously watched. Thus, according to an embodiment of the present invention, the playing device may monitor whether the advertisement as contained in the first media stream has finished, while playing the second media stream. Upon monitoring that the advertisement has finished, the playing device may resume playing of the first media stream.

The playing device further includes:

a second monitoring module configured to monitor whether play time for the advertisement has ended and generate a monitor result;

a second controlling module configured to control the playing module to play the first media stream when the monitor result indicates that the play time for the advertisement has ended.

There may be a number of approaches for the second monitoring module to determine whether the play time for an advertisement has ended, which will be detailed in the following.

The first monitoring approach is as follows.

If the playing device continues receiving the first media stream after switching to the second media stream, the second monitoring module may monitor whether the reception of the advertisement as contained in the first media stream has finished based on the received label for the media content in the first media stream. If it is monitored that the reception of the advertisement has finished, it is determined that the play time for the advertisement h has ended.

The second monitoring approach is as follows.

Prior to switching to the second media stream, the playing device may acquire the play time for the advertisement (e.g. by downloading an advertisement play time table from a corresponding server) and start a timer for the play time for the advertisement. After the timer has expired, it is determined that the play time for the advertisement has ended.

The third monitoring approach is as follows.

Upon monitoring that the first media stream contains an advertisement, the playing device may acquire the play time for the advertisement and set a timer for the play time.

Regardless of whether the user decides to switch to the second media stream or not, the timer information may be displayed on the display screen of the playing device. In particular, the play time for the advertisement may be displayed in a countdown or a time bar form, such that the user may determine whether the play time for the advertisement has ended based on the timer information. Further, in the case where the user has decided to switch to the second media stream and the timer information indicates that the play time for the advertisement has ended, the user may switch back to the first media stream by using a TV remoter, a mouse or a keyboard.

The playing device further includes:

a timer module configured to set a timer for the play time for an advertisement when the monitor result indicates that the first media stream contains the advertisement and generate timer information; and

a third prompting module configured to prompt the timer information to the user such that the user can determine whether the play time for the advertisement has ended based on the timer information.

The fourth monitoring approach is as follows.

If the playing device plays the first and the second media streams simultaneously in a dual-window mode, the user may watch the playing window corresponding to the first media stream by himself or herself to see whether the advertisement has finished. Upon seeing that the advertisement has finished, the user may change the playing window for the first media stream into a full-screen mode and close the playing window for the second media stream by using a TV remoter, a mouse or a keyboard.

It is to be understood that the playing device may maintain information on the first media stream (e.g., channel information, network address information, etc.) while switching to the second media stream. When the play time for the advertisement as contained in the first media stream has ended, the playing device may switch back to the first media stream based on the maintained information on the first media stream.

However, in some cases, after switching to the second media stream, the user may not wish to switch back to the first media stream. Thus, in a preferred embodiment, upon determining that the play time for the advertisement as contained in the first media stream has ended, the playing device may prompt the user as to whether to switch back to the first media stream. For example, switching prompt information may be displayed on the display screen for prompting the user as to whether to switch or not. If the user instructs to switch back to the first media stream, the playing device performs the switching operation; otherwise, it continues playing the second media stream.

The second controlling module may further include:

a second prompting module configured to prompt the user as to whether to play the first media stream when the monitor result indicates that the play time for the advertisement has ended; and

a second executing module configured to control the playing module to play the first media stream upon receiving a conformation instruction that the user wants to play the first media stream.

Again, for different playing devices, the user may select whether to switch back to the first media stream or not by using a TV remoter, a mouse or a keyboard. If the user selects to switch back to the first media stream, the playing device performs the switching operation. If the user selects not to switch back to the first media stream, the playing device continues playing the second media stream. If the user does not make any selection, the playing device may operate according to predetermined settings, for example, the user may autonomously set that making no selection means switching back or not switching back.

With the playing device according to the above embodiment, when the first media stream currently being received contains an advertisement, the advertisement may not be played and the second media stream may be played instead, such that the user may not be disturbed by the advertisement. In addition, it is possible to switch back to the previously watched first media stream after the play time for the advertisement has ended, thereby improving user experience.

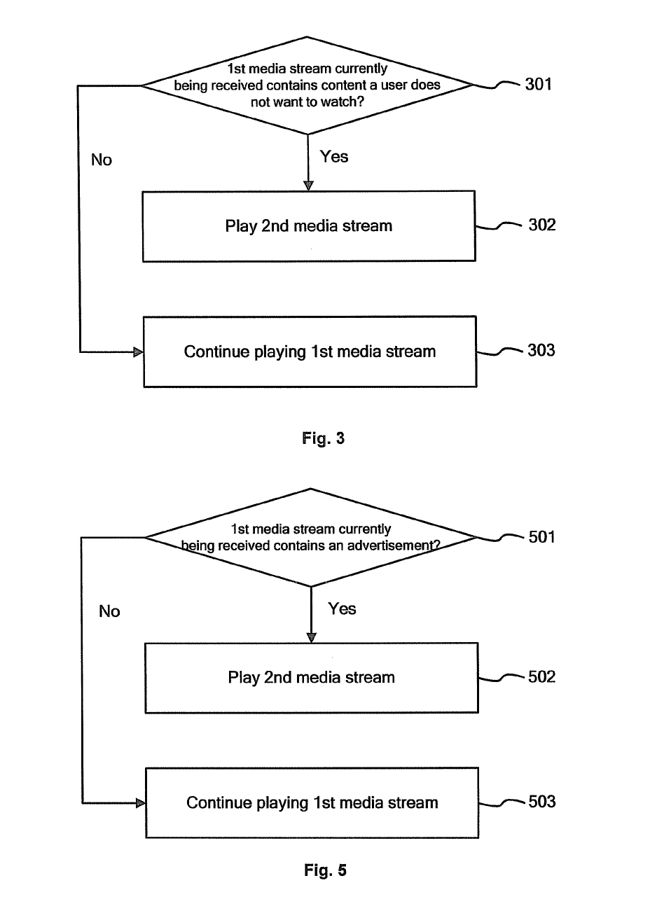

A playing method corresponding to the above playing device is also provided, as shown in FIG. 3, which includes the following steps.

At step 301, it is monitored whether a first media stream currently being received contains a content a user does not want to watch, and a monitor result is generated.

At step 302, a second media stream is played when the monitor result indicates that the first media stream contains the content the user does not want to watch. The second media stream is different from the first media stream and contains a content the user wants to watch.

At step 303, the first media stream continues to be played when the monitor result indicates that the first media stream does not contain the content the user does not want to watch.

Here, the second media stream may be a local media stream stored in advance in the playing device, e.g., a locally stored video file, a music file, a picture or a webpage. The playing device may acquire the storage path of the local media stream and play the local media stream based on the storage path.

Alternatively, the second media stream may be a network media stream on the Internet. The playing device may acquire the network address of the network media stream and play the network media stream based on the network address.

As another alternative, the second media stream may be a media stream on a preset TV channel. The playing device may acquire the channel information of the preset TV channel and play the media stream on the preset TV channel based on the channel information.

It is to be noted that, after switching to the preset TV channel, it is possible to continue monitoring the media stream on the preset TV channel as currently received. If it is detected that the media stream on the preset TV channel as currently received contains a content the user does not want to watch, it is possible to continue switching to another preset TV channel or a local media stream or a network media stream, until a second media stream whose current content is the content the user wants to watch is found.

When it is monitored that the first media stream currently being received contains the content the user does not want to watch, the playing device may immediately stop receiving the first media stream. Alternatively, the playing device may continue receiving the first media stream without playing it. As another alternative, the first and the second media streams may be played in a dual-window mode. That is, two play windows may be displayed on the current display screen for playing the first and the second media streams, respectively. For example, the second media stream may be played in a larger play window to be watched by the user, while the first media stream may be played in a smaller play window.

With the playing device according to the above embodiment, when the first media stream currently being received contains the content the user does not want to watch, the content the user does not want to watch may not be played and the second media stream containing the content the user wants to watch may be played instead, such that the user may not be disturbed by the content he or she does not want to watch.

In the above step 301, there may be a number of approaches to determine whether the first media stream currently being received contains the content the user does not want to watch, which will be detailed in the following.

The first monitoring approach is as follows.

It is assumed that, in a media stream, different media contents may be distinguished by different labels. For example, a label “1” may be added to the first byte of the media stream to indicate that the media stream relates to a movie, while a label “0” may be added to the first byte of the media stream to indicate that the media stream relates to an advertisement.

A label for the content the user does not want to watch may be stored in advance in the playing device. A label monitoring program may be installed in the playing device to detect the label for the media content currently received, so as to determine whether the received content is the content the user does not want to watch.

The second monitoring approach is as follows.

It is assumed that the TV programs to be played in a particular day on a TV channel and the play time thereof are preset. When a user watches the TV channel through the playing device, the playing device may download the play time table from a server and acquire the play time for the content the user does not want to watch from the play time table. Meanwhile, a play time monitoring program may be provided to monitor whether the play time for the content the user does not want to watch has started. When it is monitored that the play time for the content the user does not want to watch has started, it may be determined that the first media stream currently being received contains the content the user does not want to watch.

The third monitoring approach is as follows.

The playing device may compare the currently received video frame with one or more previously received video frames and calculate the correlation between them to determine whether the currently received video frame is a video frame for the content the user does not want to watch. In this way, it is possible to determine whether the first media stream currently being received contains the content the user does not want to watch.

The fourth monitoring approach is as follows.

The playing device may be provided with a video frame database in advance to store a first video frame for the content the user does not want to watch. A video frame matching program may also be provided to match the currently received video frame with the first video frame. When the currently received video frame matches the first video frame, it is determined that the first media stream currently being received contains the content the user does not want to watch.

In addition to the above monitoring approaches, other approaches may be used in the step 301 to monitor whether the first media stream currently being received contains the content the user does not want to watch. The present invention is not limited to the above approaches.

As described in connection with the above embodiments, when the first media stream currently being received contains the content the user does not want to watch, the content the user does not want to watch may not be played and the second media stream may be played instead. In this case, the content the user does not want to watch may be effectively blocked. However, in some cases, even if the first media stream contains the content the user does not want to watch, the user may wish that the first media stream may continue to be played. In such cases, automatic switching to the second media stream disobeys the user's intention. Thus, in a preferred embodiment, upon detecting that the first media stream currently being received contains the content the user does not want to watch, the playing device may first prompt the user as to whether to switch to the second media stream or not. The switching operation may be performed if the user instructs to switch to the second media stream. Otherwise the first media stream may continue to be played.

Therefore, in particular, the above step 302 includes the following steps:

prompting the user as to whether to play the second media stream when the monitor result indicates that the first media stream contains the content the user does not want to watch; and

playing the second media stream upon receiving a confirmation instruction that the user wants to play the second media stream.

Typically, after the content the user does not want to watch has finished, the user may wish to switch back to the first video stream he or she previously watched. Thus, according to an embodiment of the present invention, the playing device may monitor whether the content the user does not want to watch as contained in the first media stream has finished, while playing the second media stream. Upon monitoring that the content the user does not want to watch has finished, the playing device may play the first media stream again.

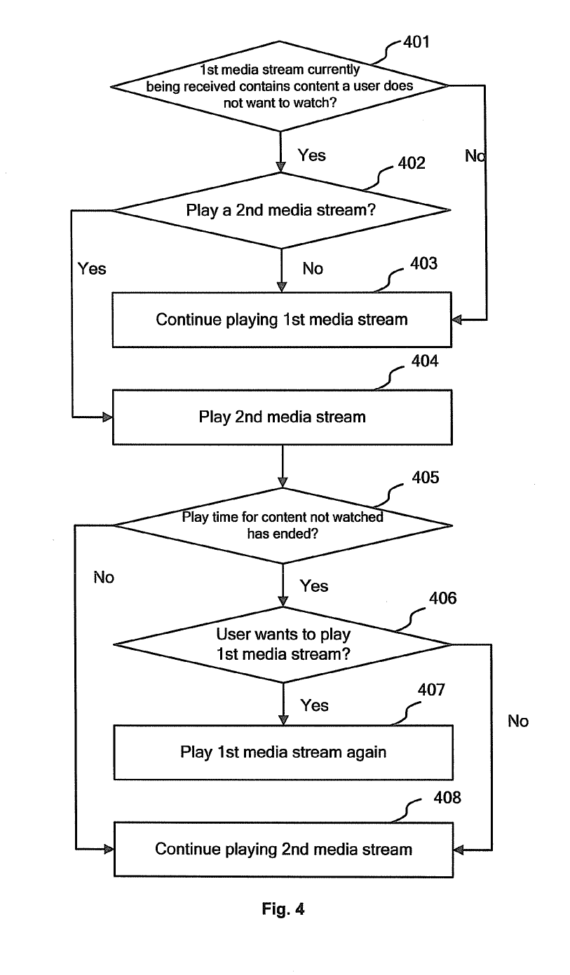

FIG. 4 is a flowchart illustrating another playing method according to an embodiment of the present invention, which includes the following steps.

At step 401, it is monitored whether a first media stream currently being received contains a content a user does not want to watch and a monitor result is generated. If the monitor result indicates that the first media stream contains the content the user does not want to watch, the method proceeds with step 402; otherwise the method proceeds with step 404.

At step 402, it is determined whether the user wants to play a second media stream which is different from the first media stream and contains a content the user wants to watch. If a confirmation instruction that the user wants to play the second media stream is received, the method proceeds with step 403; otherwise the method proceeds with step 404.

At step 403, the second media stream is played.

At step 404, the first media stream continues to be played.

At step 405, it is monitored whether the play time for the content the user does not want to watch has ended and a monitor result is generated. If the monitor result indicates that the play time for the content the user does not want to watch has ended, the method proceeds with step 406; otherwise the method proceeds with step 408.

At step 406, it is determined whether the user wants to play the first media stream. If a confirmation instruction that the user wants to play the first media stream is received, the method proceeds with step 407; otherwise the method proceeds with step 408.

At step 407, the first media stream is played.

At step 408, the second media stream continues to be played.

In the above step 405, there may be a number of approaches to determine whether the play time for the content the user does not want to watch has ended, which will be detailed in the following.

The first monitoring approach is as follows.

If the playing device continues receiving the first media stream while switching to the second media stream, it is monitored whether the reception of the content the user does not want to watch as contained in the first media stream has finished based on the received label for the media content in the first media stream. If it is monitored that the reception of the content the user does not want to watch has finished, it is determined that the play time for the content the user does not want to watch has ended.

The second monitoring approach is as follows.

Prior to switching to the second media stream, the playing device may acquire the play time for the content the user does not want to watch and start a timer for the play time for the content the user does not want to watch. After the timer has expired, it is determined that the play time for the content the user does not want to watch has ended.

The third monitoring approach is as follows.

Upon monitoring that the first media stream contains the content the user does not want to watch, the playing device may acquire the play time for the content the user does not want to watch and set a timer for the play time.

Regardless of whether the user decides to switch to the second media stream or not, the timer information can be displayed on the display screen of the playing device, such that the user may determine whether the play time for the content the user does not want to watch has ended based on the timer information. Further, in the case where the user has decided to switch to the second media stream and the timer information indicates that the play time for the content the user does not want to watch has ended, the user may switch back to the first media stream by using a TV remoter, a mouse or a keyboard.

The method further includes, after step 401:

setting a timer for the play time for the content the user does not want to watch when the monitor result indicates that the first media stream contains the content the user does not want to watch and generating timer information; and

prompting the timer information to the user such that the user can determine whether the play time for the content the user does not want to watch has ended based on the timer information.

The fourth monitoring approach is as follows.

If the playing device plays the first and the second media streams simultaneously in a dual-window mode, then the user may watch the playing window corresponding to the first media stream by himself or herself to see whether the content the user does not want to watch has finished. Upon seeing that the content the user does not want to watch has finished, the user may change the playing window for the first media stream into a full-screen mode and close the playing window for the second media stream by using a TV remoter, a mouse or a keyboard.

In the following embodiments, the playing method according to the present invention will be explained assuming advertisements as the content the user does not want to watch.

FIG. 5 is a flowchart illustrating yet another playing method according to an embodiment of the present invention, which includes the following steps.

At step 501, it is monitored whether a first media stream currently being received contains an advertisement, and a monitor result is generated.

At step 502, a second media stream is played when the monitor result indicates that the first media stream contains an advertisement. The second media stream is different from the first media stream.

At step 503, the first media stream continues to be played when the monitor result indicates that the first media stream does not contain an advertisement.

Here, the second media stream can be a local media stream stored in advance in the playing device, e.g., a locally stored video file, a music file, a picture or a webpage. The playing device may acquire the storage path of the local media stream and play the local media stream based on the storage path.

Alternatively, the second media stream may be a network media stream on the Internet. The playing device may acquire the network address of the network media stream and play the network media stream based on the network address.

As another alternative, the second media stream may be a media stream on a preset TV channel. The playing device may acquire the channel information of the preset TV channel and play the media stream on the preset TV channel based on the channel information.

It is to be noted that, after switching to the preset TV channel, it is possible to continue monitoring the media stream on the preset TV channel as currently received. If it is detected that the media stream on the preset TV channel as currently received contains an advertisement, it is possible to continue switching to another preset TV channel or a local media stream or a network media stream, until a TV channel containing no advertisement is found.

When it is monitored that the first media stream currently being received contains an advertisement, the playing device may immediately stop receiving the first media stream. Alternatively, the playing device may continue receiving the first media stream without playing it. As another alternative, the first and the second media streams may be played in a dual-window mode. That is, two play windows may be displayed on the current display screen for playing the first and the second media streams, respectively. For example, the second media stream may be played in a larger play window to be watched by the user, while the first media stream may be played in a smaller play window.

In the above step 501, there may be a number of approaches to determine whether the first media stream currently being received contains an advertisement, which will be detailed in the following.

The first monitoring approach is as follows.

It is assumed that, in a media stream, different media contents can be distinguished by different labels. For example, a label “1” may be added to the first byte of the media stream to indicate that the media stream relates to a movie, while a label “0” may be added to the first byte of the media stream to indicate that the media stream relates to an advertisement.

A label for the content the user does not want to watch may be stored in advance in the playing device. A label monitoring program may be installed in the playing device to detect the label for the media content currently received, so as to determine whether the received content is an advertisement.

The second monitoring approach is as follows.

It is assumed that the TV programs to be played in a particular day on a TV channel and the play time thereof are preset. When a user watches the TV channel through the playing device, the playing device may download the play time table from a server and acquire the play time for the advertisement from the play time table. Meanwhile, a play time monitoring program may be provided to monitor whether the play time for the advertisement is reached. When it is monitored that the play time for the advertisement is reached, it may be determined that the first media stream currently being received contains the advertisement.

The third monitoring approach is as follows.

The playing device may compare the currently received video frame with one or more previously received video frames and calculate the correlation between them to determine whether the currently received video frame is a video frame for an advertisement. In this way, it is possible to determine whether the first media stream currently being received contains an advertisement.

The fourth monitoring approach is as follows.

The playing device may be provided with a video frame database in advance to store a first video frame for an advertisement. A video frame matching program may also be provided to match the currently received video frame with the first video frame. When the currently received video frame matches the first video frame, it is determined that the first media stream currently being received contains the advertisement.

In addition to the above monitoring approaches, other approaches may be used in the step 501 to monitor whether the first media stream currently being received contains an advertisement. The present invention is not limited to the above approaches.

As described in connection with the above embodiments, when the first media stream currently being received contains an advertisement, the advertisement may not be played and the second media stream may be played instead. In this case, the content the use does not want to watch may be effectively blocked. However, in some cases, even if the first media stream contains an advertisement, the user may wish that the first media stream may continue to be played. In such cases, automatic switching to the second media stream disobeys the user's intention. Thus, in a preferred embodiment, upon detecting that the first media stream currently being received contains an advertisement, the playing device may first prompt the user as to whether to switch to the second media stream or not. The switching operation may be performed if the user instructs to switch to the second media stream. Otherwise the first media stream may continue to be played.

In particular, the above step 502 includes the following steps:

prompting the user as to whether to play the second media stream when the monitor result indicates that the first media stream contains an advertisement; and

playing the second media stream upon receiving a confirmation instruction that the user wants to play the second media stream.

Typically, after the advertisement has finished, the user may wish to switch back to the first video stream he or she previously watched. Thus, according to an embodiment of the present invention, the playing device may monitor whether the advertisement as contained in the first media stream has finished, while playing the second media stream. Upon monitoring that the advertisement has finished, the playing device may play the first media stream again.

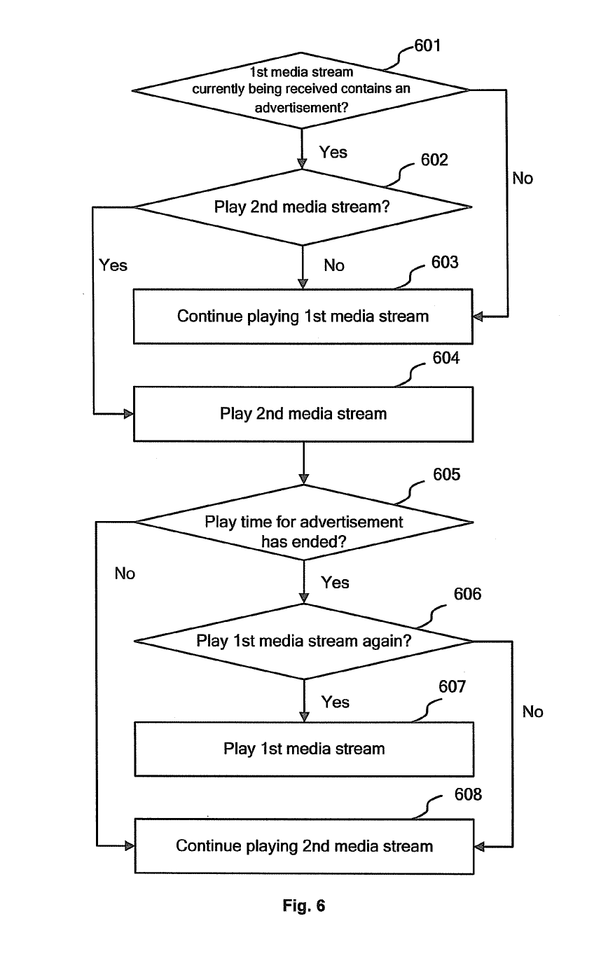

FIG. 6 is a flowchart illustrating still yet another playing method according to an embodiment of the present invention, which includes the following steps.

At step 601, it is monitored whether a first media stream currently being received contains an advertisement, and a monitor result is generated. If the monitor result indicates that the first media stream contains an advertisement, the method proceeds with step 602; otherwise the method proceeds with step 606.

At step 602, it is determined whether the user wants to play a second media stream which is different from the first media stream. If a confirmation instruction that the user wants to play the second media stream is received, the method proceeds with step 603; otherwise the method proceeds with step 606.

At step 603, the second media stream is played.

At step 604, the first media stream continues to be played.

At step 605, it is monitored whether the play time for the advertisement has ended, and a monitor result is generated. If the monitor result indicates that the play time for the advertisement has ended, the method proceeds with step 606; otherwise the method proceeds with step 608.

At step 606, it is determined whether the user wants to play the first media stream. If a confirmation instruction that the user wants to play the first media stream is received, the method proceeds with step 607; otherwise the method proceeds with step 608.

At step 607, the first media stream is played.

At step 608, the second media stream continues to be played.

In the above step 605, there may be a number of approaches to determine whether the play time for the advertisement has ended, which will be detailed in the following.

The first monitoring approach is as follows.

If the playing device continues receiving the first media stream after switching to the second media stream, it is monitored whether the reception of the advertisement as contained in the first media stream has finished based on the received label for the media content in the first media stream. If it is monitored that the reception of the advertisement has finished, it is determined that the play time for the advertisement has ended.

The second monitoring approach is as follows.

Prior to switching to the second media stream, the playing device may acquire the play time for the advertisement and start a timer for the play time for the advertisement. After the timer has expired, it is determined that the play time for the advertisement has ended.

The third monitoring approach is as follows.

Upon monitoring that the first media stream contains an advertisement, the playing device may acquire the play time for the advertisement and set a timer for the play time.

Regardless of whether the user decides to switch to the second media stream or not, the timer information can be displayed on the display screen of the playing device, such that the user may determine whether the play time for the advertisement has ended based on the timer information. Further, in the case where the user has decided to switch to the second media stream and the timer information indicates that the play time for the advertisement has ended, the user may switch back to the first media stream by using a TV remoter, a mouse or a keyboard.

As mentioned the above, the method further includes, after step 601:

setting a timer for the play time for the advertisement when the monitor result indicates that the first media stream contains the advertisement and generating timer information; and

prompting the timer information to the user such that the user can determine whether the play time for the advertisement has ended based on the timer information.

The fourth monitoring approach is as follows.

If the playing device plays the first and the second media streams to simultaneously in a dual-window mode, then the user may watch the playing window corresponding to the first media stream by himself or herself to see whether the advertisement has finished. Upon seeing that the advertisement has finished, the user may change the playing window for the first media stream into a full-screen mode and close the playing window for the second media stream by using a TV remoter, a mouse or a keyboard.

With the playing device according to the above embodiment, when the first media stream currently being received contains an advertisement, the advertisement may not be played and the second media stream may be played instead, such that the user may not be disturbed by the advertisement. In addition, it is possible to switch back to the first media stream previously watched after the play time for the advertisement has ended, thereby improving user experience.

FIG. 7 is a schematic diagram showing yet another structure of a playing device according to an embodiment of the present invention. The playing device may be a TV, a Set Top Box (STB) connected to a TV display screen, a computer, a handset or the like. The media resource currently being played by the playing device is assumed to be a first media stream which may contain two types of contents, a content the user wants to watch and a content the user does not want to watch. The contents the user does and does not want to watch can be set by the user in advance and stored in the playing device. For example, the content the user wants to watch may be TV series and movies, while the content the user does not want to watch can be advertisements and news.

Conventionally, when the first media stream currently being played contains the content the user does not want to watch, the user may switch to play the second media stream whose current content is a content the user wants to watch. However, after switching to the second media stream, it is impossible to switch back to the first media stream in a timely manner, that is, when the content the user does not want to watch as contained in the first media stream has finished.

In order to switch back to the first media stream in timely manner, the playing device according to an embodiment of the present invention further includes the following components.

A monitoring module 701 is configured to monitor whether the first media stream currently being received contains a content a user does not want to watch, and generate a monitor result. In particular, the monitoring module 701 can determine the first media stream currently being received contains a content the user does not want to watch by using the same method as that used by the first monitoring module 102 in the embodiment as described above, for which the detailed description will be omitted here.

A timer module 702 is configured to set a timer for the play time for the content the user does not want to watch when the monitor result indicates that the first media stream contains the content the user does not want to watch, and generate timer information. An example for acquiring the play time for content the user does not want to watch in a media stream on a TV channel will be described. Assume that the TV programs to be played in a particular day on a TV channel and the play time thereof are preset. For example, a TV channel, CCTV1, will play “News Broadcast” at 19:00 and “Weather Forecast” at 19:40, with advertisements inserted between the “News Broadcast” and “Weather Forecast”. These TV programs and their play time may be stored in advance in a play time table. When a user watches the TV channel CCTV1 through the playing device, the playing device may download the play time table from a server (in some cases the TV channel may automatically transmit the play time table to the playing device) and acquire the play time for the content the user does not want to watch from the play time table.

A prompting module 703 is configured to prompt the timer information to the user such that the user may determine whether the play time for the content the user does not want to watch has ended based on the timer information. In this case, regardless of whether the user decides to switch to the second media stream or not, the timer information may be displayed on the display screen of the playing device, such that the user may determine whether the play time for the content the user does not want to watch has ended based on the timer information. In particular, the timer information for the content the user does not want to watch may be displayed in a countdown or a time bar form.

Further, in the case where the user has decided to switch to the second media stream and the timer information indicates that the play time for the content the user does not want to watch has ended, the user may switch back to the first media stream by using a TV remoter, a mouse or a keyboard.

In the following embodiments, the above playing device will be explained assuming advertisements as the content the user does not want to watch.

The playing device may be a TV, a Set Top Box (STB) connected to a TV display screen, a computer, a handset or the like. The media source currently being played by the playing device is assumed to be a first media stream. Conventionally, when the first media stream currently being played contains an advertisement, the user may switch to play a second media stream. However, after switching to the second media stream, it is impossible to switch back to the first media stream in a timely manner, that is, when the advertisement as contained in the first media stream has finished.

In order to switch back to the first media stream in a timely manner, the playing device according to an embodiment of the present invention further includes the following components.

A monitoring module is configured to monitor whether the first media stream currently being received contains an advertisement and generate a monitor result. In particular, the monitoring module may determine the first media stream currently being received contains an advertisement by using the same method as that used by the first monitoring module 102 in the embodiment as described above, for which the detailed description will be omitted here.

A timer module is configured to set a timer for the play time for the advertisement when the monitor result indicates that the first media stream contains the advertisement and generate timer information. An example for acquiring the play time for an advertisement in a media stream on a TV channel will be described. Assume that the TV programs to be played in a particular day on a TV channel and the play time thereof are stored in advance in a play time table. When a user watches the TV channel through the playing device, the playing device may download the play time table from a corresponding server and acquire the play time for the advertisement from the play time table.

A prompting module is configured to prompt the timer information to the user such that the user can determine whether the play time for the advertisement has ended based on the timer information. In this case, regardless of whether the user decides to switch to the second media stream or not, the timer information may be displayed on the display screen of the playing device, such that the user may determine whether the play time for the advertisement has ended based on the timer information. In particular, the timer information for the advertisement can be displayed in a countdown or a time bar form.

Further, in the case where the user has decided to switch to the second media stream and the timer information indicates that the play time for the advertisement has ended, the user may switch back to the first media stream by using a TV remoter, a mouse or a keyboard.

The preferred embodiments of the present invention have been described above. It should be noted that a number of variations and modifications can be made by those skilled in the art without departing from the principle of the present invention. These variations and modifications are to be encompassed by the scope of the present invention.

What is claimed is:

1. A playing device, comprising:
a playing module configured to play a first media stream currently being received;
a first monitoring module configured to monitor whether the first media stream contains a content a user does not want to watch and to generate a monitor result;
a first controlling module configured to control the playing module to play a second media stream in response to the monitor result indicating that the first media stream contains the content the user does not want to watch, the second media stream being different from the first media stream and containing a content the user wants to watch.

2. The playing device of claim 1, wherein first controlling module is configured to control the playing module to play the second media stream by:
playing the second media stream while stopping receiving the first media stream, or
playing the second media stream while continuing receiving, without playing, the first media stream;
playing the first media stream and the second media stream simultaneously in different windows on a display screen of the playing device.

3. The playing device of claim 1, wherein the second media stream comprises at least one of:
a local media stream pre-stored in the playing device;
a network media stream; and
a media stream on a preset channel.

4. The playing device of claim 1, wherein the first monitoring module comprises:
a first label detecting module configured to detect a label for media content contained in the first media stream currently being received and to generate a first detection result; and
a first determining module configured to determine that the first media stream contains the content the user does not want to watch in response to the first detection result indicating that the label for media content contained in the first media stream is a label for the content the user does not want to watch.

5. The playing device of claim 1, wherein the first monitoring module comprises:
a first play time acquiring module configured to acquire play time for the content the user does not want to watch contained in the first media stream;
a first play time monitoring module configured to monitor whether the play time for the content the user does not want to watch has started and to generate a first time monitor result; and
a second determining module configured to determine that the first media stream contains the content the user does not want to watch in response to the first time monitor result indicating that the play time for the content the user does not want to watch has started.

6. The playing device of claim 1, wherein the first monitoring module comprises:
a video frame acquiring module configured to acquire video frames in the first media stream currently being received;
a correlation calculating module configured to calculate a correlation between a currently acquired video frame and one or more preceding video frames; and
a third determining module configured to determine that the first media stream contains the content the user does not want to watch when the correlation is smaller than a preset threshold.

7. The playing device of claim 1, wherein the first monitoring module comprises:
a video frame storing module configured to store in advance a first video frame for a content the user does not want to watch;
a video frame matching module configured to match a video frame in the first media stream currently being received with the first video frame and to generate a match result; and
a fourth determining module configured to determine that the first media stream contains the content the user does not want to watch in response to the match result indicating that the video frame matches the first video frame.

8. The playing device of claim 1, wherein the first controlling module comprises:
a first prompting module configured to prompt the user as to whether to play the second media stream when the monitor result indicates that the first media stream contains the content the user does not want to watch; and
a first executing module configured to control the playing module to play the second media stream upon receiving an instruction that the user wants to play the second media stream.

9. The playing device of claim 1, further comprising:
a second monitoring module configured to monitor whether play time for the content the user does not want to watch has ended and to generate a monitor result;
a second controlling module configured to control the playing module to play the first media stream in response to the monitor result indicating that the play time for the content the user does not want to watch has ended.

10. The playing device of claim 9, wherein the second monitoring module comprises:
a second label detecting module configured to detect a label for media content in the first media stream while continuing receiving the first media stream and to generate a second detection result; and
a fifth determining module configured to determine that the play time for the content the user does not want to watch contained in the first media stream has ended in response to the second detection result indicating that the label for media content contained in the first media stream is a label for the content the user wants to watch.

11. The playing device of claim 9, wherein the second monitoring module comprises:
a second play time acquiring module configured to acquire play time for the content the user does not want to watch contained in the first media stream before playing the second media stream;
a second play time monitoring module configured to monitor the play time for the content the user does not want to watch and to generate a second time monitor result; and
a sixth determining module configured to determine that the play time for the content the user does not want to watch has ended in response to the second time monitor result indicating that the play time for the content the user does not want to watch has ended.

12. The playing device of claim 9, wherein the second controlling module comprises:
a second prompting module configured to prompt the user as to whether to play the first media stream when the monitor result indicates that the play time for the content the user does not want to watch has ended; and
a second executing module configured to control the playing module to play the first media stream upon receiving an instruction that the user wants to play the first media stream.

13. The playing device of claim 1, further comprising:
a timer module configured to set a timer for the play time for the content the user does not want to watch in response to the monitor result indicating that the first media stream contains the content the user does not want to watch and to generate timer information; and
a third prompting module configured to prompt the timer information to the user such that the user can determine whether the play time for the content the user does not want to watch has ended based on the timer information.

14. A playing method, comprising:
playing a first media stream currently being received;
monitoring whether the first media stream contains a content a user does not want to watch, and generating a monitor result;
playing a second media stream in response to the monitor result indicating that the first media stream contains the content the user does not want to watch, the second media stream being different from the first media stream and containing a content the user wants to watch.

15. The playing method of claim 14, wherein playing the second media stream comprises:
playing the second media stream while stopping receiving the first media stream, or
playing the second media stream while continuing receiving, without playing, the first media stream; or
playing the first media stream and the second media stream simultaneously in different windows on a display screen of a playing device.

16. The playing method of claim 14, wherein the monitoring step comprises:
detecting a label for media content contained in the first media stream currently being received and generating a first detection result; and
determining that the first media stream contains the content the user does not want to watch in response to the first detection result indicating that the label for media content contained in the first media stream is a label for the content the user does not want to watch.

17. The playing method of claim 14, wherein the monitoring step comprises:
acquiring play time for the content the user does not want to watch contained in the first media stream;
monitoring whether the play time for the content the user does not want to watch has started, and generating a first time monitor result; and
determining that the first media stream contains the content the user does not want to watch in response to the first time monitor result indicating that the play time for the content the user does not want to watch has started.

18. The playing method of claim 14, wherein the monitoring step comprises:
acquiring video frames in the first media stream currently being received;
calculating a correlation between a currently acquired video frame and one or more preceding video frames; and
determining that the first media stream contains the content the user does not want to watch when the correlation is smaller than a preset threshold.

19. The playing method of claim 14, wherein the monitoring step comprises:
matching a video frame in the first media stream currently being received with a pre-stored first video frame for a content the user does not want to watch, and generating a match result; and
determining that the first media stream contains the content the user does not want to watch in response to the match result indicating that the video frame matches the first video frame.

20. The playing method of claim 14, wherein playing a second media stream in response to the monitor result indicating that the first media stream contains the content the user does not want to watch comprises:
prompting the user as to whether to play the second media stream when the monitor result indicates that the first media stream contains the content the user does not want to watch; and
playing the second media stream upon receiving an instruction that the user wants to play the second media stream.

21. The playing method of claim 14, further comprising, after playing the second media stream:
monitoring whether play time for the content the user does not want to watch has ended, and generating a monitor result;
playing the first media stream in response to the monitor result indicating that the play time for the content the user does not want to watch has ended.

22. The playing method of claim 21, wherein the step of monitoring after playing the second media stream:
detecting a label for media content in the first media stream while continuing receiving the first media stream, and generating a second detection result; and
determining that the play time for the content the user does not want to watch contained in the first media stream has ended in response to the second detection result indicating that the label for media content contained in the first media stream is a label for the content the user wants to watch.

23. The playing method of claim 21, wherein the step of monitoring after playing the second media stream:
acquiring play time for the content the user does not want to watch as contained in the first media stream before playing the second media stream;
monitoring the play time for the content the user does not want to watch, and generating a second time monitor result; and
determining that the play time for the content the user does not want to watch has ended in response to the second time monitor result indicating that the play time for the content the user does not want to watch has ended.

24. The playing method of claim 21, wherein playing the first media stream in response to the monitor result indicating that the play time for the content the user does not want to watch has ended comprises:
prompting the user as to whether to play the first media stream when the monitor result indicates that the play time for the content the user does not want to watch has ended; and
playing the first media stream upon receiving an instruction that the user wants to play the first media stream.

25. The playing method of claim 14, further comprising, after the monitoring step:
setting a timer for the play time for the content the user does not want to watch in response to the monitor result indicating that the first media stream contains the content the user does not want to watch and generating timer information; and
prompting the timer information to the user such that the user can determine whether the play time for the content the user does not want to watch has ended based on the timer information.
